(19) United States
(12) Patent Application Publication
(10) Pub. No.: US 2019/0282969 A1
(43) Pub. Date: Sep. 19, 2019

(54) Graphene Oxide Membrane With A Controllable Interlayer Spacing, A Preparation Method And Use Thereof

(71) Applicants: Shanghai Institute of Applied Physics, Chinese Academy of Sciences, Shanghai (CN); Shanghai University, Shanghai (CN); Nanjing Tech University, Jiangsu (CN)

(72) Inventors: Haiping Fang, Shanghai (CN); Minghong Wu, Shanghai (CN); Guosheng Shi, Shanghai (CN); Gang Xu, Shanghai (CN); Liang Chen, Shanghai (CN); Wanqin Jin, Jiangsu (CN); Jie Shen, Jiangsu (CN)

(21) Appl. No.: 16/318,616

(22) PCT Filed: May 25, 2017
(86) PCT No.: PCT/CN2017/085900

§ 371 Date: Jan. 17, 2019

(30) Foreign Application Priority Data
Jul. 20, 2016 (CN) 201610575159.5

(51) Int. Cl. B01D 67/00; B01D 71/02; C01B 32/198

(52) U.S. Cl. CPC B01D 67/0093; B01D 71/024; B01D 2323/50; B01D 2325/42; C01B 32/198

(57) ABSTRACT

A graphene oxide membrane with a controllable interlayer spacing, a preparation method and use thereof are provided. The preparation method provides of infiltrating a graphene oxide membrane in an aqueous solution A of salt to swell, thereby obtaining the graphene oxide membrane with the controllable interlayer spacing. The aqueous solution A of salt is a solution containing metal cation, and the concentration of the metal cation in the aqueous solution A is from 0.25-2.5 mol/L. The application can precisely control the size of the interlayer spacing of the graphene oxide membrane in the range of 11˜14 Å, and the variable range of this spacing can be controlled to within 0.6˜1 Å. The graphene oxide membrane with the controllable interlayer spacing of the application has excellent mechanical strength, which remains a complete membrane state after 5 hours of infiltration. The preparation process is simple and easy to be operated, and the obtained graphene oxide membrane has a function of screening and filtering smaller ions, and thus has a good application prospect.

### CROSS REFERENCE TO RELATED APPLICATION

This application claims the priority of Chinese Patent Application No. 201610575159.5 filed on Jul. 20, 2016, the entire disclosure of which is hereby incorporated by reference.

### BACKGROUND OF THE INVENTION

### 1. Field of the Invention

The present invention relates generally to a graphene oxide membrane with a controllable interlayer spacing, a preparation method and use thereof.

### 2. Related Art

Graphene oxide membrane has excellent filter membrane characteristics such as ultra-thin, high flux, and energy-efficient, and thus it is considered to be a next-generation filter membrane for ionic and molecular sieving (Science 2011, 333, 712-717). The graphene oxide membrane has shown potential in a variety of applications, including water desalination and purification (Science 2011, 332, 674-676; Science 2012, 335, 442-444; Adv Funct Mater 2013, 23, 3693-3700), gas separation (Acs Nano 2016, 10, 3398-3409), biosensors (Nano Lett. 2010, 10, 3163), proton conductors (Nano Lett. 2008, 8, 2458; Nature 2014, 516, 227), lithium batteries (J Am Chem Soc 2012, 134, 8646-54), supercapacitors (Acs Nano 2011, 5, 5463-5471) and other fields. Unlike the fixed pore size of the carbon nanotubes, the pores of graphene oxide membranes—that is, the interlayer spacing between graphene oxide sheets (a sheet is a single flake inside the membrane)—are of variable size. In particular, it is difficult to reduce the interlayer spacing sufficiently to exclude small ions and to maintain this spacing against the tendency of graphene oxide membranes to swell when immersed in aqueous solution, which greatly affects the stability of the graphene oxide membrane in the filtration application.

Moreover, the size of the interlayer spacing of unmodified graphene oxide membrane is about 1.3 nm, and only the solute with a hydrated ionic radius greater than 0.45 nm can be separated and filtered. However, the hydrated ionic radius of Na⁺, Mg²⁺, Ca²⁺, K⁺, Li⁺ or the like, which are ubiquitous in actual environment such as seawater, are smaller than this critical value, therefore the ion filtration in seawater desalination and sewage purification cannot be truly achieved by the unmodified graphene oxide membrane.

So far, for the graphene oxide membrane, the existing methods for controlling the interlayer spacing include intercalating large nanomaterials as well as by cross-linking large and rigid molecules, both of them can increase the interlayer spacing. However, the size of the interlayer spacing controlled and obtained through these methods is above 2 nm, and thus only the molecular clusters of above 2 nm can be separated and filtered. But a smaller size cannot be precisely controlled by these methods. For example, the prior art of “Science 2014, 343, 740-742; Environ, Sci. Technol. 2013, 47, 3715-3723” discloses that the larger rigid chemical groups are used to crosslink for increasing the interlayer spacing, and the entire disclosure of which is hereby incorporated by reference. The prior art of “Adv Mater 2016, 28, 2287-2310” discloses that the oxygen-containing groups on the graphene sheet are partially reduced (wherein the interlayer spacing of the graphene oxide membrane is formed by graphene oxide sheets, and the size of channels is affected by the content of the oxygen-containing groups on the sheet layers), thereby the effect of reducing the interlayer spacing is achieved by the reduced groups. Although the oxygen-containing groups are reduced by the method, the size of channels are re-increased due to the swelling effect after immersed in the solution, and the entire disclosure of which is hereby incorporated by reference.

Due to the swelling effect of the solution, there is still a great challenge to maintain the interlayer spacing in a smaller size to effective ions sieving in the solution immersion state (Adv Mater 2016, 28, 2287-2310). It is the most difficult to separate target ions from an aqueous solution, or to reject ions of a certain size range from a mixed salt solution, such as the separation of the most prevalent Na⁺, Mg²⁺, Ca²⁺, K⁺, and Li⁺ from seawater, lithium-based batteries, or supercapacitors (Science 2014, 343, 740-742; Nano Lett 2014, 14, 1234-1241; Adv Mater 2016, 28, 2287-2310). Therefore, how to accurately reduce the interlayer spacing of graphene oxide, and how to maintain the size of the interlayer spacing in the immersion state during the sieving and rejecting process, to sieving or rejection of ions, such as Na⁺, Mg²⁺, Ca²⁺, K⁺ and Li⁺, with a hydration radius of less than 0.45 nm by the graphene oxide membrane, are urgent problems to be solved in the application of graphene oxide membrane in seawater desalination and sewage purification.

### SUMMARY OF THE INVENTION

The technical problem to be solved by the present application is that the prior art adopts a chemical grafting method to adjust the size of the interlayer spacing of the graphene oxide membrane, wherein the size is above 2 nm and cannot be accurately controlled in a smaller size. Moreover, due to the swelling effect of the solution, although the interlayer spacing may be reduced in the solution immersion state, it is still a great challenge to maintain the interlayer spacing of the membrane in a smaller size to effectively ions sieving. The purpose of the present application is to provide a graphene oxide membrane with a controllable interlayer spacing, a preparation method and use thereof. The application can precisely control the size of the interlayer spacing of the graphene oxide membrane in the range of 11˜14 Å, and the variable range of this spacing can be controlled to within 0.6˜1 Å. The graphene oxide membrane with the controllable interlayer spacing of the application has excellent mechanical strength, which remains a complete membrane state after 5 hours of infiltration. The preparation process is simple and easy to be operated, and the obtained graphene oxide membrane has a function of sieving and rejecting smaller ions, and thus has a good application prospect.

In the current research on the application of the graphene oxide membrane in filtering ion solution, it mainly concerns that the size of the membrane channels will limit the ions, but neglects that the strong cation-x interaction between the ion and the aromatic ring structure itself will play an important role to affect the size of membrane channels. The inventors of the present application have found through research that different cations have a strong cation-x effect on the graphene oxide channels, and the size of interlayer spacing also has a corresponding change. Further, the inventors studied the control of the interlayer spacings of the graphene oxide membrane by different salt solutions, and finally realized the ion sieving and rejection in the salt solution by the ion-control of the size of interlayer spacing based on the cation-π action. The present application is a new breakthrough method of controlling layer channel in a new field.

The present application adopts following technical solutions to solve the above technical problems.

The present application provides a preparation method of a graphene oxide membrane with a controllable interlayer spacing, comprising: infiltrating a graphene oxide membrane in an aqueous solution A of salt to swell, thereby obtaining the graphene oxide membrane with the controllable interlayer spacing; wherein the aqueous solution A of salt is a solution containing metal cation, and the concentration of the metal cation in the aqueous solution A is from 0.25 to 2.5 mol/L.

In the embodiments, the graphene oxide membrane may be intact without defects such as cracks and holes.

In the embodiments, the graphene oxide membrane may be obtained from a graphene oxide solution by a conventional method in the art, preferably from a graphene oxide solution by a drop-cast method or a suction filter method. The graphene oxide membrane may also be a conventional stand-alone membrane or a support membrane in the art.

The operations and conditions of the suction filter method are routine operations and conditions in the art. The operations and conditions of the drop-cast method are routine operations and conditions in the art. The method for preparing a graphene oxide membrane by the drop-cast method preferably comprises the steps of: dropping 0.8˜1.2 mL of 3˜5 mg/mL graphene oxide solution on a smooth paper sheet, after a first drying, rinsing the paper sheet repeatedly with deionized water, and immersing the paper sheet in deionized water for half an hour and then taking the paper sheet out, after a second drying, and obtaining the graphene oxide membrane. The condition of the first drying is conventional in the art, preferably at 55˜65° C. for 5˜7 hours, more preferably at 60° C. for 6 hours. The condition of the second drying is conventional in the art, preferably at 55˜65° C. for 11˜13 hours, more preferably at 60° C. for 12 hours.

The graphene oxide solution is prepared by a conventional method in the art, preferably by an oxidative stripping graphite method (i.e., the Hummers method), more preferably by the following steps: 1) pre-oxidation of graphite: dissolving 2.5 g of potassium persulfate and 2.5 g of phosphorus pentoxide in concentrated sulfuric acid, heating to 78˜82° C.; adding 2˜4 g of natural graphite, after heat preservation, cooling to room temperature, diluting with deionized water, and then allowing to stand overnight; filtering to remove residual acid, and drying to obtain pre-oxide; 2) oxidation: mixing the pre-oxide prepared in step 1) with concentrated sulfuric acid at 0˜5° C., adding 14˜16 g of potassium permanganate, reacting at 34˜36° C. for 1.5˜2.5 hours, adding 18˜22 mL of hydrogen peroxide and reacting to obtain a mixture; 3) post-treatment: washing the mixture in step 2), and filtering, after ultrasonication in deionized water, the graphene oxide solution is obtained.

In the embodiments, in order to further control the precise range of the interlayer spacing, the ambient temperature during the infiltration is preferably 17˜23° C., more preferably at 20° C.

In the embodiments, the metal cation is conventional in the art, preferably one or more of K⁺, Na⁺, Li⁺, Ca²⁺ and Mg²⁺. When the aqueous solution A contains two or more of metal cations, the size of the interlayer spacing of the graphene oxide with controllable interlayer spacing is determined by the size of the metal cation which has a smaller size.

In the embodiments, the concentration of the metal cation in the aqueous solution A has a large control effect on the interlayer spacing. If the concentration of the metal cation is less than 0.25 mol/L, the controlled interlayer spacing may has little stability, and the actual applications such as seawater desalination applications may be limited. If the concentration of the metal cation is higher than 2.5 mol/L, the enrichment of ions may be caused in the membrane by the excessively high ion concentration, and blockage of salt may be resulted in the interlayer spacing and the water flux may be affected.

In the embodiments, the pH of the aqueous solution A is conventional in the art, preferably from 5 to 8, more preferably at 7.

In the embodiments, it is common sense that “swelling” refers to a free state in which the graphene oxide membrane is completely expanded in the aqueous solution A. The time of infiltrating is conventional in the art. In order to ensure sufficient swelling of the graphene oxide membrane, time of the infiltrating is preferably from 1 to 3 hours.

In the embodiments, the aqueous solution A of salt contains an anion which is preferably an anion capable of satisfying the size of hydrated anion smaller than the size of hydrated cation. In addition to OH⁻, the anion preferably includes one or more of F⁻, Cl⁻, Br⁻, SO₄²⁻, and NO₃⁻, and more preferably, one or more of Cl⁻, F⁻, and Br⁻;

In the embodiments, when the metal cation in the aqueous solution A of salt is K⁺, the anion preferably includes one or more of F⁻, Cl⁻, Br⁻ I⁻, and NO₃⁻ in addition to OH⁻.

In the embodiments, when the metal cation in the aqueous solution A of salt is Na⁺, the anion preferably includes one or more of F⁻, Cl⁻, Br⁻, I⁻ and NO³⁻ in addition to OH⁻.

In the embodiments, when the metal cation in the aqueous solution A of salt is Li⁺, the anion preferably includes one or more of F⁻, Cl⁻, Br⁻, I⁻ and NO³⁻ in addition to OH⁻.

In the embodiments, when the metal cation in the aqueous solution A of salt is Ca²⁺, the anion preferably includes one or more of F⁻, Cl⁻, Br⁻, I⁻ and NO³⁻ in addition to OH⁻.

In the embodiments, when the metal cation in the aqueous solution A of salt is Mg₂₊, the anion preferably includes one or more of F⁻, Cl⁻, Br⁻, I⁻, SO₄²⁻, and NO₃⁻ in addition to OH⁻.

The present application also provides a graphene oxide membrane with a controllable interlayer spacing produced by the above preparation method.

In the embodiments, the size of the interlayer spacing of the graphene oxide membrane with the controllable interlayer spacing is in the range of 11 to 14 Å, and the precise dimensional change control is performed with an amplitude of 0.6˜1 Å.

In the embodiments, the graphene oxide membrane with the controllable interlayer spacing is selected from any one of following membranes:

1): in the aqueous solution A of salt, the metal cation is K⁺, and the size of the interlayer spacing of the graphene oxide membrane with the controllable interlayer spacing is 11.4±0.1 Å;

2): in the aqueous solution A of salt, the metal cation is Na⁺, and the size of the interlayer spacing of the graphene oxide membrane with the controllable interlayer spacing is 12.1±0.2 Å;

3): in the aqueous solution A of salt, the metal cation is Ca²⁺, and the size of the interlayer spacing of the graphene oxide membrane with the controllable interlayer spacing is 12.9±0.2 Å;

4): in the aqueous solution A of salt, the metal cation is Li⁺, and the size of the interlayer spacing of the graphene oxide membrane with the controllable interlayer spacing is 13.5±0.2 Å;

5): in the aqueous solution A of the salt, the metal cation is Mg²⁺, and the size of the interlayer spacing of the graphene oxide membrane with the controllable interlayer spacing is 13.6±0.1 Å.

The present application also provides a method of the graphene oxide membrane with the controllable interlayer spacing in filtering an aqueous solution B of salt.

In the embodiments, the concentration of the aqueous solution B of salt is conventional in the art, preferably from 0.25 to 2.5 mol/L.

In the embodiments, the operation of filtering is conventional in the art, and generally, the aqueous solution B of salt is directly filtered, preferably by the following steps: controlling the interlayer spacing of the graphene oxide membrane by the aqueous solution A of salt, and then filtering the aqueous solution B of the salt by the graphene oxide membrane with the controlled interlayer spacing.

In the embodiments, the amount of the aqueous solution B of salt is preferably the same as the amount of the aqueous solution A of salt for controlling the interlayer spacing.

In the embodiments, the use is selected from any one of the following methods:

1): the graphene oxide membrane with the controllable interlayer spacing is prepared by infiltrating a graphene oxide membrane in aqueous solution A of salt containing K⁺, which entraps K⁺ and ions or molecules with hydrated radii greater than 3.31 Å, such as Na⁺, Li⁺, Ca²⁺ or Mg²⁺, but allows water molecules to pass. The main reason for the entrapment of K⁺ is that due to the instability of the hydration layer of K⁺ and the strong K⁺-π action, after the hydration K⁺ enters the membrane channel, the hydration layer is deformed and firmly adsorbed on the surface of the aromatic ring. Therefore, not only the size of the interlayer spacing is reduced, but also K⁺ itself is entrapped.

2): the graphene oxide membrane with the controllable interlayer spacing is prepared by infiltrating a graphene oxide membrane in aqueous solution A of salt containing Na⁺, which entraps ions or molecules with hydrated radii greater than 3.58 Å, such as Ca²⁺, Li⁺ or Mg²⁺, but allows ions or molecules with hydrated radii of 3.58 Å or less to pass, such as K⁺, Na⁺ and water molecules.

3): the graphene oxide membrane with the controllable interlayer spacing is prepared by infiltrating a graphene oxide membrane in aqueous solution A of salt containing Ca²⁺, which entraps ions or molecules with a hydrated ionic radius greater than 4.12 Å, such as Li⁺ or Mg²⁺, but allows ions and molecules with a hydrated ionic radius of 4.12 Å or less to pass, such as K⁺, Na⁺, Ca²⁺ and water molecules.

4): the graphene oxide membrane with the controllable interlayer spacing is prepared by infiltrating a graphene oxide membrane in the aqueous solution A of salt containing Li⁺, which entraps ions or molecules with a hydrated ionic radius greater than 3.82 Å, such as Mg²⁺, but allows ions and molecules with a hydrated ionic radius of 3.82 Å or less to pass, such as K⁺, Na⁺, Ca²⁺, Li⁺ and water molecules.

5): the graphene oxide membrane with the controllable interlayer spacing is prepared by infiltrating a graphene oxide membrane in the aqueous solution A of salt containing Mg²⁺, which entraps ions or molecules with a hydrated ionic radius greater than 4.28 Å, but allows ions and molecules with a hydrated ionic radius of 4.28 Å or less to pass, such as K⁺, Na⁺, Ca²⁺, Mg²⁺, Li⁺ and water molecules.

In the embodiments, the ions include cation and anion unless otherwise specified.

Based on the common sense in the art, the above various preferred conditions can be arbitrarily combined to obtain preferred embodiments.

The materials used in the embodiments are all commercially available.

The positive effects of the present application are as follows:

The application can precisely control the size of the interlayer spacing of the graphene oxide membrane in the range of 11˜14 Å, and perform precise dimensional change with an amplitude of 0.6˜1 Å. The graphene oxide membrane with the controllable interlayer spacing of the application has excellent mechanical strength, which remains a complete membrane state after 5 hours of infiltration. The preparation process is simple and easy to be operated, and the obtained graphene oxide membrane has a function of screening and filtering smaller ions, and thus has a good application prospect. Moreover, the preparation method has a universal applicability to the graphene oxide membrane prepared by various existing methods.

### BRIEF DESCRIPTION OF THE DRAWINGS

FIG. 1 is a topographical view of graphene oxide membrane of Example 1, wherein A is a physical photo of graphene oxide membrane, B is a scanning electron microscope view of a surface topography of graphene oxide membrane, and C is an atomic force microscope view of a surface topography of graphene oxide membrane.

FIG. 2 is a graph showing the interlayer spacing data of the products obtained by immersing the graphene oxide membranes in different salt solutions in Examples 2 to 6 and in pure water.

FIG. 3 is a graph showing the interlayer spacing data of graphene oxide membranes with controllable interlayer spacings after being infiltrated in different solutions.

FIG. 4 is a graph showing the results of graphene oxide membranes and graphene oxide membranes with controllable interlayer spacings after adsorption of salt solution in different solutions, wherein A is a graph showing the results of graphene oxide membranes after adsorption of salt solution in different solutions (in each group, the wet membrane weight is on the left side and the dry membrane weight is on the right side), B is a graph showing the results of graphene oxide membranes with controllable interlayer spacings after adsorption of salt solution in different solutions (in each group, the wet membrane weight (membrane+salt solution within the membrane) is on the left side, the dry membrane weight (membrane+salt weigh within the membrane) is on the left side)).

### DESCRIPTION OF THE PREFERRED EMBODIMENT

The application is further illustrated by the following examples, which are not intended to limit the application. The experimental methods in the following examples, which do not specify the specific conditions, are selected according to conventional methods and conditions, or according to the manufacturer's instructions.

### Example 1

Preparation method of graphene oxide solution (modified Hummers method):

1) Pre-oxidation of graphite: 2.5 g of potassium persulfate (K₂S₂O₈) and 2.5 g of phosphorus pentoxide (P₂O₅) are dissolved in 12 mL of concentrated sulfuric acid, and heated to 80° C. 3 g of natural graphite is added to the above solution, and incubated at 80° C. for 4.5 h. The obtained solution is cooled to room temperature, diluted with 500 mL of deionized water, and stand overnight. Residual acid is removed by filtrating with a 0.2 mm filter. The pre-oxide is obtained by drying in a vacuum oven at 60° C.

2) Oxidation: the obtained pre-oxide is added to 120 mL of concentrated sulfuric acid in an ice bath, and 15 g of KMnO₄ is slowly added while stirring and the temperature should be kept below 20° C. during the stirring. It is then stirred at 35° C. for 2 hours. 250 mL of deionized water is then added, and the dilution process should also be conducted in an ice bath so that the temperature is controlled below 50° C. After stirred for another 2 hours, 0.7 L of deionized water is added, and 20 mL of 30% H₂O₂ is immediately added. After the above mixing, bubbles are generated in the solution, and the color changes from brown to bright yellow, and the reaction is terminated after about 0.5 hours.

3) Post-treatment: the above mixture is filtered and washed with 1 L of 1:10 dilute hydrochloric acid, wherein the purpose of filtration is to remove part of metal ions. Then it is washed with 1 L of water to remove excess acid. The solution is dissolved in 1 L of deionized water. Then, a graphene oxide solution is obtained by ultrasonic at 100 W for about 0.5 hour, in which the carbon content is about 5 mg/mL.

The method for preparing graphene oxide membrane by a drop-cast method comprises the following steps:

1 mL of 3˜5 mg/mL graphene oxide solution is dropped on a smooth paper sheet, which is dried in an oven at 60° C. for about 12 h. The independent graphene oxide membrane is removed and rinsed repeatedly with deionized water. After being infiltrated in a large amount of deionized water for half an hour, the graphene oxide membrane is taken out, dried at 60° C. for 6 hours, and then placed in a drying vessel for use. The obtained graphene oxide membrane has a thickness of about 30 μm.

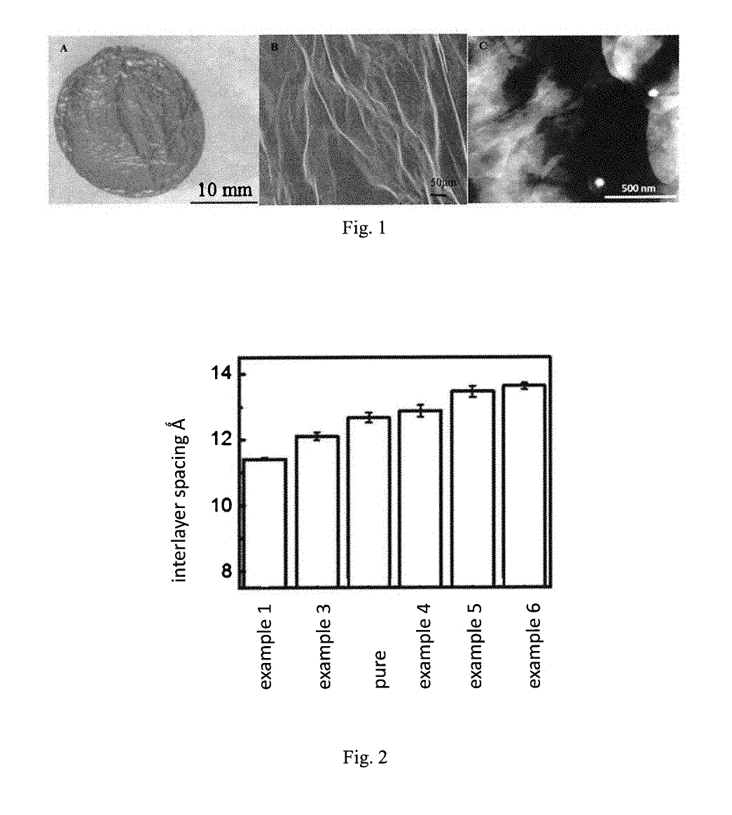

FIG. 1 is a topographical view of graphene oxide membrane of Example 1, wherein A is a physical photo of graphene oxide membrane, B is a scanning electron microscope view of a surface topography of graphene oxide membrane, and C is an atomic force microscope view of a surface topography of graphene oxide membrane.

The graphene oxide membrane prepared in this Example has the characteristics of ultra-thin, high flow rate, energy-saving and the like, and has independent and unsupported mechanical strength, and can be directly used for saltwater screening and separation.

### Example 2

A sample of the graphene oxide membrane prepared in Example 1 is infiltrated in 0.25 mol/L KCl solution for 1 h (pH 7 and ambient temperature is 20° C.) so that the raw material is fully swelled, and the corresponding graphene oxide membrane with a controllable interlayer spacing is obtained. XRD is used to detect the size of interlayer spacing.

### Example 3

A sample of the graphene oxide membrane prepared in Example 1 is infiltrated in 0.25 mol/L NaCl solution for 1 h (pH 7 and ambient temperature is 20° C.) so that the raw material is fully swelled, and the corresponding graphene oxide membrane with a controllable interlayer spacing is obtained. XRD is used to detect the size of the interlayer spacing.

### Example 4

A sample of the graphene oxide membrane prepared in Example 1 is infiltrated in 0.25 mol/L CaCl₂) solution for 1 h (pH 7 and ambient temperature is 20° C.) so that the raw material is fully swelled, and the corresponding graphene oxide membrane with a controllable interlayer spacing is obtained. XRD is used to detect the size of the interlayer spacing.

### Example 5

A sample of the graphene oxide membrane prepared in Example 1 is infiltrated in 0.25 mol/L LiCl solution for 1 h (pH 7 and ambient temperature is 20° C.) so that the raw material is fully swelled, and the corresponding graphene oxide membrane with a controllable interlayer spacing is obtained. XRD is used to detect the size of the interlayer spacing.

### Example 6

A sample of the graphene oxide membrane prepared in Example 1 is infiltrated in 0.25 mol/L MgCl₂ solution for 1 h (pH 7 and ambient temperature is 20° C.) so that the raw material is fully swelled, and the corresponding graphene oxide membrane with a controllable interlayer spacing is obtained. XRD is used to detect the size of the interlayer spacing.

Effect Example 1

XRD (X-ray diffractometer) is used to detect the size of the interlayer spacing of the graphene oxide membranes with controllable interlayer spacings of the embodiments.

FIG. 2 is a graph showing the interlayer spacing data of the products obtained by immersing the graphene oxide membranes in different salt solutions in Examples 2 to 6 and in pure water. It can be seen that the graphene oxide membranes with different interlayer spacings will be obtained by immersing the graphene oxide membranes in different salt solutions.

Four samples of the graphene oxide membrane prepared in Example 1 are infiltrated in 0.25 mol/L KCl solution for 1 h (pH 7 and ambient temperature is 20° C.) so that the raw materials are fully swelled, and the corresponding graphene oxide membranes with controllable interlayer spacings are obtained. Then, an equal amount of 0.25 mol/L NaCl solution, CaCl₂ solution, LiCl solution and MgCl₂ solution are added to form a mixed salt solution, in which the membranes are infiltrated for 0.5 hour (pH 7, and ambient temperature is 20° C.). XRD is then used to detect the size of the interlayer spacing.

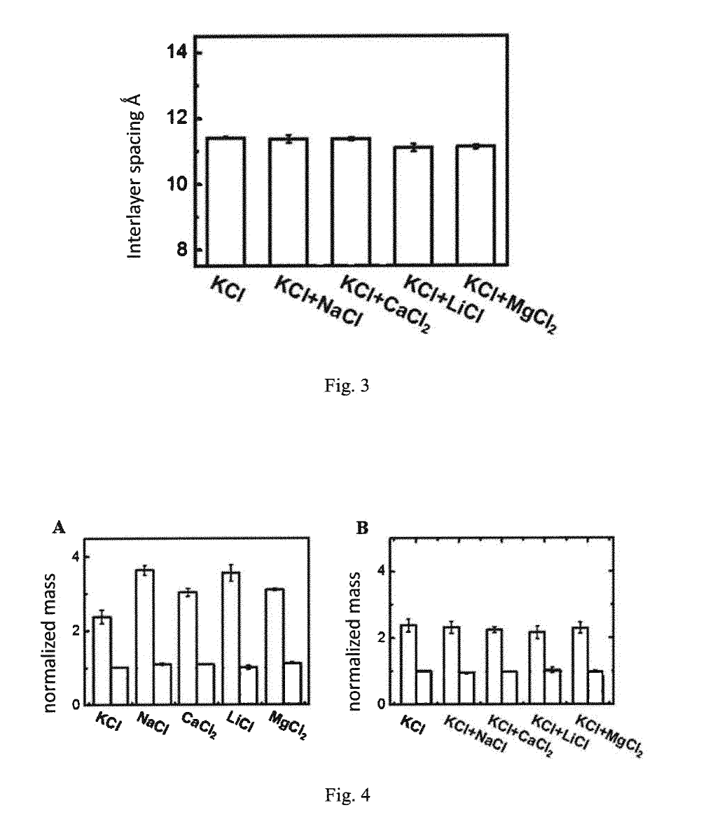

FIG. 3 is a graph showing the interlayer spacing data of graphene oxide membranes with controllable interlayer spacings after being infiltrated in different solutions. It can be seen that, as to the graphene oxide membrane with the controllable interlayer spacing controlled by KCl, the interlayer spacing without adding any salt solution is substantially the same as the interlayer spacing after adding an equal amount of other salt solution. Thus, the obtained interlayer spacing is very stable after being controlled by KCl, and is not affected by the subsequent addition of other salt solutions. The subsequent addition of the salt solution cannot increase the size of the interlayer spacing, that is to say, the ion for controlling the smaller size of the interlayer spacing has a trapping effect to the other ions.

### Effect Example 2

The ability of absorbing the salt solution of graphene oxide membrane is detected as follows:

Four samples of the graphene oxide membrane obtained in Example 1 are infiltrated in 0.25 mol/L KCl solution, NaCl solution, LiCl solution, CaCl₂) solution and MgCl₂ solution respectively for 1 hour (pH 7 and ambient temperature is 20° C.). The above infiltrating solution is removed, and the water on the surfaces of the membranes is removed by centrifugation. The wet membrane is weighed and placed in an oven at 60° C. for 6 hours, and then the dry membrane is weighed.

The ability of absorbing the salt solution of graphene oxide membranes with controllable interlayer spacings are detected as follows:

Four samples of the graphene oxide membrane prepared in Example 1 are infiltrated in 0.25 mol/L KCl solution for 1 hour (pH 7 and ambient temperature is 20° C.) so that the raw materials are fully swelled, and the corresponding graphene oxide membranes with controllable interlayer spacings are obtained. Then, an equal amount of 0.25 mol/L NaCl solution, CaCl₂) solution, LiCl solution and MgCl₂ solution are added to form a mixed salt solution, in which the membranes are infiltrated for 0.5 hour. The above infiltrating solution is removed, and the water on the surfaces of the membranes is removed by centrifugation. The wet membrane is weighed and placed in an oven at 60° C. for 6 hours, and then the dry membrane is weighed.

FIG. 4 is a graph showing the results of graphene oxide membranes and graphene oxide membranes with controllable interlayer spacings after adsorption of salt solution in different solutions, wherein A is a graph showing the results of graphene oxide membranes after adsorption of salt solution in different solutions (in each group, the wet membrane weight is on the left side and the dry membrane weight is on the right side), B is a graph showing the results of graphene oxide membranes with controllable interlayer spacings after adsorption of salt solution in different solutions (in each group, the wet membrane weight (membrane+salt solution within the membrane) is on the left side, the dry membrane weight (membrane+salt weight within the membrane) is on the left side)). It can be seen from A, when the graphene oxide membranes are immersed in five kinds of salt solutions, respectively, the salt water adsorptions of the membranes are different are larger, and a certain amount of salt after drying is contained in the membranes. It can be seen from B, when the graphene oxide membranes are infiltrated in KCl solution firstly and then an equal amount of other salt solutions is subsequently added, the adsorption amount of salt solution is substantially same to that of the pure KCl solution, and the weight of the dried membrane is substantially same to the weight of dried membrane after immersed in pure KCl solution. It shows that the KCl solution can effectively prevent the penetration of other salt solutions after adjusting the membrane channel, which is obviously less than the adsorption amount of other salt solutions after infiltration, but the weight of wet membrane is still about 2.4 times that of the dry membrane, which indicates that water molecules can still penetrate into the membrane.

While the invention has been described with above preferred embodiments, it should be understood by the person skilled in the art that the embodiments are only examples, and may be altered or modified without departing from the spirit and scope of the invention.

Accordingly, the scope of the invention is defined by the appended claims.

1. A method of preparing a graphene oxide membrane with a controllable interlayer spacing, comprising:
infiltrating a graphene oxide membrane in an aqueous solution A of salt to swell, thereby obtaining the graphene oxide membrane with the controllable interlayer spacing,
wherein the aqueous solution A of salt is a solution containing metal cation, and the concentration of the metal cation in the aqueous solution A is from 0.25 to 2.5 mol/L.

2. The method according to claim 1, wherein the graphene oxide membrane is prepared from a graphene oxide solution through a drop-cast method or a suction filter method.

3. The method according to claim 2, wherein the first drying is at 55˜65° C. for 5˜7 hours;
and/or, the second drying is at 55˜65° C. for 11˜13 hours.

4. The method according to claim 1, wherein during the infiltration, ambient temperature is from 17 to 23° C.;
the metal cation is one or more of K⁺, Na⁺, Li⁺, Ca²⁺, and Mg²⁺;
the pH of the aqueous solution A is 5˜8;
and/or, the time of the infiltration is from 1 to 3 hours.

5. The method according to claim 1 wherein the aqueous solution A of salt contains an anion which is an anion wherein the size of hydrated anion is smaller than hydrated cation;
in the aqueous solution A of salt, when the metal cation is K⁺, the anion includes one or more of F⁻, Cl⁻, Br⁻, I⁻, and NO₃⁻ in addition to OH⁻;
and/or, in the aqueous solution A of salt, when the metal cation is Na⁺, Li⁺ or Ca²⁺, the anion includes one or more of F⁻, Cl⁻, Br⁻, I⁻ and NO³⁻ in addition to OH⁻;
and/or, in the aqueous solution A of salt, when the metal cation is Mg²⁺, the anion includes one or more of F⁻, Cl⁻, Br⁻, I⁻, SO₄²⁻, and NO₃⁻ in addition to OH⁻.

6. A graphene oxide membrane with a controllable interlayer spacing produced by the method according to claim 1.

7. The graphene oxide membrane according to claim 6, wherein the graphene oxide membrane with the controllable interlayer spacing is selected from any one of following membranes:
1) in the aqueous solution A of salt, the metal cation is K⁺, and the size of the interlayer spacing of the graphene oxide membrane with the controllable interlayer spacing is 11.4±0.1 Å;
2) in the aqueous solution A of salt, the metal cation is Na⁺, and the size of the interlayer spacing of the graphene oxide membrane with the controllable interlayer spacing is 12.1±0.2 Å;
3) in the aqueous solution A of salt, the metal cation is Ca²⁺, and the size of the interlayer spacing of the graphene oxide membrane with the controllable interlayer spacing is 12.9±0.2 Å;
4) in the aqueous solution A of salt, the metal cation is Li⁺, and the size of the interlayer spacing of the graphene oxide membrane with the controllable interlayer spacing is 13.5±0.2 Å;
5) in the aqueous solution A of the salt, the metal cation is Mg²⁺, and the size of the interlayer spacing of the graphene oxide membrane with the controllable interlayer spacing is 13.6±0.1 Å.

8. A method wherein the graphene oxide membrane with the controllable interlayer spacing according to claim 7 is used in filtering an aqueous solution B of salt.

9. The method according to claim 8, wherein the aqueous solution B of salt has a concentration of from 0.25 to 2.5 mol/L;
the operation of filtering is carried out according to following steps: controlling the interlayer spacing of the graphene oxide membrane by the aqueous solution A of salt, and then filtering the aqueous solution B of the salt by the graphene oxide membrane with the controlled interlayer spacing;
and/or, the amount of the aqueous solution B of salt is the same as the amount of the aqueous solution A for controlling the interlayer spacing.

10. The method according to claim 9, wherein the graphene oxide membrane with the controllable interlayer spacing is prepared by any one of the following methods:
1) the graphene oxide membrane with the controllable interlayer spacing is prepared by infiltrating a graphene oxide membrane in aqueous solution A of salt containing K⁺, which entraps K⁺ and ions or molecules with hydrated radii greater than 3.31 Å, but allows water molecules to pass;
2) the graphene oxide membrane with the controllable interlayer spacing is prepared by infiltrating a graphene oxide membrane in aqueous solution A of salt containing Na⁺, which entraps ions or molecules with hydrated radii greater than 3.58 Å, but allows ions or molecules with a hydrated ionic radius of 3.58 Å or less to pass;
3) the graphene oxide membrane with the controllable interlayer spacing is prepared by infiltrating a graphene oxide membrane in aqueous solution A of salt containing Ca²⁺, which entraps ions or molecules with a hydrated ionic radius greater than 4.12 Å, but allows ions and molecules with a hydrated ionic radius of 4.12 Å or less to pass;
4) the graphene oxide membrane with the controllable interlayer spacing is prepared by infiltrating a graphene oxide membrane in the aqueous solution A of salt containing Li⁺, which entraps ions or molecules with a hydrated ionic radius greater than 3.82 Å, but allows ions and molecules with a hydrated ionic radius of 3.82 Å or less to pass; or
5) the graphene oxide membrane with the controllable interlayer spacing is prepared by infiltrating a graphene oxide membrane in the aqueous solution A of salt containing Mg²⁺, which entraps ions or molecules with a hydrated ionic radius greater than 4.28 Å, but allows ions and molecules with a hydrated ionic radius of 4.28 Å or less to pass.

11. The method according to claim 2, wherein the method for preparing the graphene oxide membrane through the drop-cast method comprises: dropping 0.8˜1.2 mL of 3˜5 mg/mL graphene oxide solution on a paper sheet, after a first drying, rinsing the paper sheet repeatedly with deionized water, and immersing the paper sheet in deionized water for half an hour and then taking the paper sheet out, after a second drying, obtaining the graphene oxide membrane.

12. The method according to claim 3, wherein the first drying is performed at 60° C. for 6 hours.

13. The method according to claim 3, wherein the second drying is performed at 60° C. for 12 h.

14. The method of claim 4, wherein during infiltrating, the ambient temperature is 20° C.

15. The method of claim 4, wherein the pH of the aqueous solution is at 7.

16. The method of claim 5, wherein in addition to OH⁻, the anion is one or more of Cl⁻, F⁻, Br⁻, SO₄²⁻, and NO₃⁻.

17. The method of claim 5, wherein in addition to OH⁻, the anion is one or more of Cl⁻, F⁻, and Br⁻.
